(19) United States
(12) Patent Application Publication
(10) Pub. No.: US 2026/0045841 A1
(43) Pub. Date: Feb. 12, 2026

(54) MAGNETIC ROTOR APPARATUS FOR A SIDE CHANNEL COMPRESSOR FOR A FUEL CELL SYSTEM, SIDE CHANNEL COMPRESSOR AND METHOD OF MANUFACTURING A MAGNETIC ROTOR APPARATUS FOR A SIDE CHANNEL COMPRESSOR FOR A FUEL CELL SYSTEM

(71) Applicant: Robert Bosch GmbH, Stuttgart (DE)

(72) Inventors: Frank Jennewein, Martinshoehe (DE); Frank Laemmle, Winnenden (DE); Rene Schepp, Waiblingen (DE)

(21) Appl. No.: 18/998,585

(22) PCT Filed: Jun. 29, 2023
(86) PCT No.: PCT/EP2023/067777

§ 371 Date: Jan. 27, 2025

(30) Foreign Application Priority Data
Jul. 27, 2022 (DE) 10 2022 207 721.0

(51) Int. Cl. H02K 1/2793; H02K 15/035

(52) U.S. Cl. CPC H02K 1/2793; H02K 15/035

(57) ABSTRACT

Magnetic rotor apparatus (2) for a side channel compressor (1) for a fuel cell system (31) for conveying and/or compacting a gaseous medium, in particular hydrogen, wherein the magnetic rotor apparatus (2) is supported about an axis of rotation (4) in such a manner that it can be rotated and/or can be driven by means of a drive (6), wherein the magnetic rotor apparatus (2) comprises a compressor wheel (10), a gas flow can be generated by means of the gas flow, in particular in a compressor space (30), a hub (9), a locking ring (22) and at least one bearing (27, 47).

According to the invention, the hub (9) comprises a recess (13) that extends annularly around the axis of rotation (4) and can be encapsulated by a rotor space (46), wherein the components of the locking ring (22) and at least two segment magnets (24), ideally four segment magnets (24), are at least almost completely in the recess (13). The locking ring (22) is connected to the hub (9) by means of at least one dowel pin (42) and/or a screw element

The invention further relates to a side channel compressor (1) having a magnetic rotor apparatus (2) according to the invention and/or a fuel cell system (31) and/or a method for manufacturing the magnetic rotor apparatus (2).

### BACKGROUND

The present invention relates to a magnetic rotor apparatus for a side channel compressor for a fuel cell system, a side channel compressor, and a method of manufacturing a magnetic rotor apparatus for a side channel compressor for a fuel cell system.

In the automotive sector, in addition to liquid fuels, gaseous fuels will also play an increasing role in the future. In particular in vehicles with fuel cell drive, hydrogen gas flows need to be controlled. The gas flows are no longer controlled discontinuously, as they are with liquid fuel injection; instead the gaseous medium is withdrawn from at least one high-pressure tank and directed to an ejector unit via a supply line of a medium-pressure line system. This ejector unit feeds the gaseous medium to a fuel cell via a connecting line of a low-pressure line system. After the gaseous medium has flowed through the fuel cell, it is fed back to the ejector unit via a return line. The side channel compressor can be interconnected to support the flow and efficiency of gas recirculation. In addition, side channel compressors are used to assist in building up the flow in the fuel cell drive, particularly in case of a (cold) start-up of the vehicle after a certain service life. These side channel compressors are typically powered by electric motors that are supplied with voltage by the vehicle battery when operating in vehicles.

A side channel compressor for a fuel cell system is known from DE 10 2018 222 102 A1, in which a gaseous medium, in particular hydrogen, is conveyed and/or compressed. The side channel compressor comprises a housing and a drive, wherein the housing comprises a housing upper part and a housing lower part, with a compressor space circumferential in the housing about an axis of rotation comprising at least one circumferential side channel, with a compressor wheel located in the housing arranged such that it can be rotated about the axis of rotation and driven by the drive. The compressor wheel comprises blades arranged at its periphery in the area of the compressor space and is equipped with a gas inlet opening formed on the housing and a gas outlet opening that are connected via a fluidic connection through the compressor space, in particular the at least one side channel, wherein the side channel compressor comprises at least one bearing. In addition, it is shown in DE 10 2018 222 102 A1 that a rotor assembly, which can be designed as a permanent magnet, is located on a driver flange corresponding to a hub.

The side channel compressor known from DE 10 2018 222 102 A1 can have certain disadvantages. The rotor assembly and/or the permanent magnet is located on the driver flange and is not encapsulated by a rotor space, in particular the rotor assembly and/or the permanent magnet is not fluidly encapsulated by the rotor space. When the side channel compressor is in use, hydrogen can intrude into the rotor space and damage the metal components and/or the rotor assembly and/or the permanent magnet, in particular through hydrogen embrittlement. In this case, the rotor assembly and/or the permanent magnet may fail, such that the compressor wheel and/or a magnetic rotor apparatus can no longer be driven by means of the drive, in particular by means of a stator and rotor assembly, so that the probability of failure of the drive and thus the entire side channel compressor increases.

A further disadvantage of the side channel compressor known in DE 10 2018 222 102 Al is that a locking ring and/or the permanent magnet is pressed into the hub, forming an interference fit with the hub, especially with its inner diameter, whereby, a deformation of the hub, in particular a bearing bore and/or a bearing seat, results due to the stresses involved, in the bearing bore and/or bearing seat needing to be remachined, which increases costs due to the additional process step.

### SUMMARY

The invention provides for a magnetic rotor apparatus for a side channel compressor for a fuel cell system for conveying and/or compacting a gaseous medium, in particular hydrogen, with the features of the independent claims. The magnetic rotor apparatus is at least almost entirely enclosed in a rotor space and is supported by a axis of rotation in such a manner that it can be rotated, and/or can be driven by means of a drive. The magnetic rotor apparatus comprises a compressor wheel by means of which a gas flow can be produced in particular in a compressor space, a hub, a locking ring and at least one bearing.

The hub comprises an annular recess which extends around the axis of rotation and which can be encapsulated by the rotor space, wherein the components of the locking ring and at least two segment magnets, ideally four segment magnets, are located at least almost completely in the recess. The locking ring is connected to the hub by means of at least one dowel pin and/or a screw element.

This makes it possible to achieve multiple advantages. On the one hand, it allows for a compact and space-saving arrangement and design for the magnetic rotor apparatus, because the components of the locking ring and segment magnet can be integrated in the recess and thus in the hub, whereby the magnetic rotor apparatus is narrower in the direction of the rotational axis compared to the magnetic rotor apparatus from the prior art.

In addition, this makes it possible to achieve the advantage that the locking ring is connected to the hub by means of at least one dowel pin and/or a screw element. Thus, no further components are necessary for connecting the locking ring to the hub, which can reduce component costs. Furthermore, such a stable connection can be formed between the locking ring and the hub by inserting at least one dowel pin and/or a screw element, such that the hub and locking ring components are connected to each other in a positive-locking manner and/or in a material-locking manner and/or in a friction-locking manner via the dowel pin and/or the screw element, such that this connection remains stable over the entire service life and disconnecting the components is nearly impossible. Thus, the service life of the magnetic rotor apparatus and/or the side channel compressor and/or the fuel cell system can be increased.

According to an advantageous further development of the magnetic rotor apparatus, the respective dowel pin and/or the respective screw element comprise a head and a body, wherein the head has a larger diameter than the body. This makes it possible to achieve a compact design for the connection between the locking ring and the hub, in particular by means of the respective dowel pin and/or the respective screw element. The head face of the respective dowel pin and/or the respective screw element can come into contact with a further element, wherein the end face is at least nearly orthogonal to the axis of rotation, and thus exert a force, in particular a compressive force, on the further element. In this way, a connection can be formed that does not place a shear load on the respective dowel pin and/or the respective screw element; rather, it is possible to make a friction-locking connection via the face of the head with a further element. Thus, the likelihood of the dowel pin and/or the screw element failing can be reduced, so that the service life of the magnetic rotor apparatus and/or the side channel compressor can be increased.

According to an advantageous further development of the magnetic rotor apparatus, the respective dowel pin and/or the respective screw element are located with the head in a first recess of the locking ring and with the body in a second recess of the locking ring and a third recess of the hub. In this way, the advantage can be achieved that a reliable connection can be established between the locking ring and the hub without affecting a bearing fit of the hub and/or the compressor wheel. The positive-locking and/or friction-type connection of the locking ring and the hub by means of the respective dowel pin and/or the respective screw element has a high strength, so that the components of the locking ring and the hub remain stably connected to one another over the entire service life of the side channel compressor or the fuel cell system. In addition, such a connection between the components can be completed in a very compact manner by means of the respective dowel pin and/or the respective screw element, which can reduce the size of the overall side channel compressor. This in turn may reduce the required installation space of the side channel compressor in the overall vehicle.

According to a particularly advantageous embodiment of the magnetic rotor apparatus, the body of the respective dowel pin has a larger diameter than the respective third recess, such that a friction-locking and/or friction-type connection, in particular a compression joint, is formed between the respective dowel pin and/or the hub. In this way, a simple and inexpensive connection can be achieved between the hub and the dowel pin, wherein the service life of this connection can be ensured over the entire time the side channel compressor is in use, so that the probability of the magnetic rotor apparatus and/or the side channel compressor failing can be reduced.

According to an advantageous configuration of the magnetic rotor apparatus, the third recess in the hub has a thread, in particular an internal thread, and the respective screw element has a thread in the area of the body, in particular an external thread, wherein the screw element is screwed to the hub. In this way, the screw element can be screwed into the hub by means of a fast and cost-efficient method step, wherein a friction-locking connection is achieved between the head of the screw element and/or the locking ring and/or the hub by applying such a high screw-in torque that the screw element extends in the direction of the axis of rotation. This causes a reliable connection between the screw element and/or locking ring and/or hub components over the entire service life of the side channel compressor. In addition, the connection can be disconnected in a non-destructive manner if components, such as the locking ring, need to be replaced during the service life of the magnetic rotor apparatus and/or the side channel compressor. Thus, maintenance costs can be reduced.

According to an advantageous further development of the magnetic rotor apparatus, the respective dowel pin and/or the respective screw element run at least approximately parallel to the axis of rotation or are positioned at least approximately parallel to the axis of rotation. In this way, the advantage of inexpensive and quick assembly of the respective dowel pin and screw element can be achieved. In addition, the components of the locking ring and/or the hub can be machined inexpensively prior to assembly so that the bore can be aligned to receive the dowel pin and/or the screw element parallel to a bearing bore, which results in simplified and cost-effective machining on the respective manufacturing machines for the hub and/or the locking ring. Thus, manufacturing costs and/or assembly costs can be reduced.

According to a particularly advantageous further development of the magnetic rotor apparatus, the respective dowel pin and/or the respective screw element are located in a non-central area of a first central axis of a threaded hole and the axis of rotation. In this way, the connection between the locking ring and the hub can be arranged as far away from the bearing bore as possible, so that formation of the connection between the hub and the locking ring does not cause any deformation in the bearing bore which would necessitate post-processing. Thus, the costs, particularly the machining costs, of the magnetic rotor apparatus can be reduced and/or the likelihood of failure of the magnetic rotor apparatus due to bearing damage caused by deformation of the bearing bore can be reduced.

As the preferred scope of application of the magnetic rotor apparatus according to the present invention is a side channel compressor and/or a fuel cell system, a side channel compressor and/or a fuel cell system is further proposed with the magnetic rotor apparatus according to the present invention.

According to an advantageous configuration in the proposed method of manufacturing the magnetic rotor apparatus for the side channel compressor and/or a fuel cell system, the locking ring is provided. This locking ring is then installed in the recess of the hub. The locking ring is fixed to the hub by means of the at least one dowel pin and/or a screw element, in particular in a positive-locking or a friction-locking manner. The locking ring comprises at least two projections which run in particular in the direction of the axis of rotation; a segment magnet can be mounted between each set of two projections. In a further method step, the respective segment magnet is connected to the locking ring, in particular a face of the locking ring, and/or to the respective protrusions. This connection may be made by a positive locking and/or a material-locking and/or a friction-locking method to form the rotor assembly. In a further exemplary method step, a cover plate can be attached to the collar and the shoulder by means of a material-locking method, in particular laser welding.

A particularly advantageous configuration of the method proposes that the body of the at least one dowel pin is pressed into the third recess such that a friction-locking and/or friction-type connection forms between the respective dowel pin and the hub and thus the locking ring and/or the rotor assembly is fixed to the hub. In this way, the rotor assembly may be designed in a compact manner and assembled inexpensively, wherein the likelihood of failure of the magnetic rotor apparatus and/or the side channel compressor is reduced.

In an advantageous further development of the method, it is suggested that the at least one screw element is screwed into the third recess of the hub until the length of the screw element, the enlarged head of which is in contact with a face of the locking ring in the direction of the rotational axis is extended, so that the locking ring is connected in a friction-locking and/or friction-type and/or material-locking manner to the locking ring.

The invention is not limited to the exemplary embodiments described herein and the aspects highlighted thereby. Rather, within the range specified by the claims, a plurality of modifications is possible, which lie within the abilities of a person skilled in the art.

### BRIEF DESCRIPTION OF THE DRAWINGS

The invention is described in greater detail below with reference to the drawing.

Shown are:

FIG. 1 a schematic sectional view of a side channel compressor according to the invention,

FIG. 2 a schematic sectional view of a magnetic rotor apparatus with a compressor wheel, a hub, a locking ring and at least one bearing,

FIG. 3 a top perspective view of a rotor assembly according to the invention according to an exemplary embodiment with the locking ring with four projections and four respective segment magnets,

FIG. 4 a perspective sectional view of the rotor assembly according to the invention with a cover plate,

FIG. 5 a sectional view of the rotor assembly according to the invention pursuant to the prior art,

FIG. 6 a schematic sectional view of the magnetic rotor apparatus with a dowel pin or a screw element, the hub and the locking ring.

### DETAILED DESCRIPTION

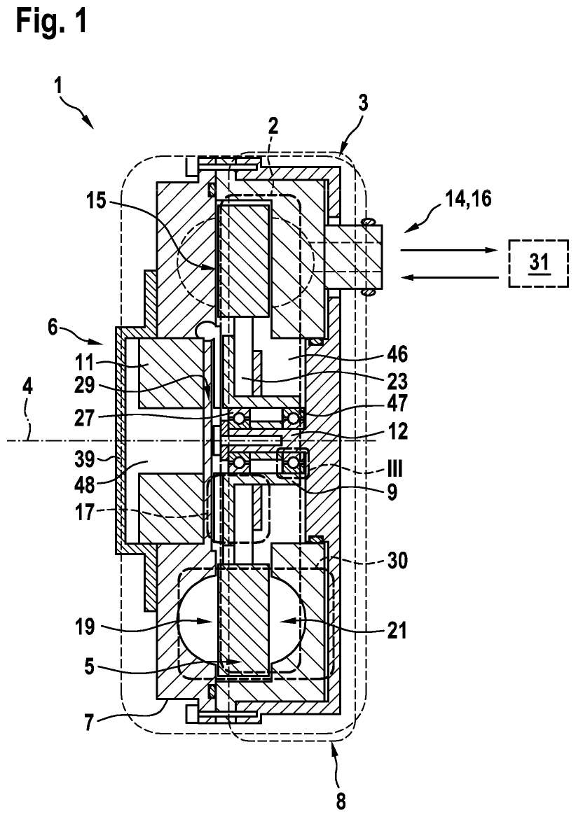

The illustration according to FIG. 1 shows a schematic sectional view of a side channel compressor 1 according to the invention.

It is shown in FIG. 1 that the side channel compressor 1 for a fuel cell system 31 is provided with a housing 3 and a drive 6 for conveying and/or compacting a gaseous medium, in particular hydrogen, wherein the housing 3 comprises a housing upper part 7 and a housing lower part 8. In addition, the housing 3 comprises a compressor space 30 extending circumferentially around an axis of rotation 4, which comprises at least one circumferential side channel 19, 21, with a magnetic rotor apparatus 2 located in the housing 3, which is arranged in such a manner that it can be rotated about the axis of rotation 4 and which is driven by the drive 6, wherein the magnetic rotor apparatus 2 comprises blades 5 arranged at its circumference in the area of the compressor space 30, each having a gas inlet opening 14 formed on the housing 3 and a gas outlet opening 16, which are connected to one another via a fluidic connection through the compressor space 30, in particular the at least one side channel 19, 21, wherein the side channel compressor 1 comprises at least one bearing 27, 47. The at least one side channel 19, 21 can extend circumferentially around the axis of rotation 4 at least in a sub-area of the housing 3, wherein an interruption area 15 is configured in the housing 3 in the sub-area in which the at least one side channel 19, 21 is not configured in the housing 3.

It is also shown in FIG. 1 that the drive 6 is designed as an axial field electric motor 6 having a stator 11 and a rotor assembly 17, wherein the stator 11 and the rotor assembly 17 are formed disc-shaped and circumferentially around the rotational axis 4 and wherein the stator 11 is arranged in the direction of the rotational axis 4 adjacent to the rotor assembly 17. The rotor assembly 17 can be located at least indirectly on or in a hub disk 23 of the magnetic rotor apparatus 2. In addition, it is shown in FIG. 1 that the side channel compressor 1 has a stator space 48 and a rotor space 46, wherein at least some of the components of the drive 6 are arranged in these spaces 46, 48. The housing upper part 7 comprises a continuous wall 29, which is located between the stator space 48 and the rotor space 46 and causes a fluidic separation of these two spaces. The stator space 48 is also at least partially surrounded and/or encapsulated by a stator housing 39. The housing lower part 8 comprises a cylindrical bearing pin 12, wherein the bearing pin 12 extends in the direction of the axis of rotation 4, such that its lateral surface extends circumferentially around the axis of rotation 4, and wherein a first bearing 27 and/or a second bearing 47 are radially contacting the axis of rotation 4 with the lateral surface of the bearing pin 12. The drive 6 can be embodied as an axial field electric motor 6 comprising a stator 11 and the rotor assembly 17, wherein the stator 11 is arranged in the direction of the axis of rotation 4 adjacent to the rotor assembly 17. In addition, the side channel compressor 1 comprises the cylindrical bearing pin 12, wherein the bearing pin 12 extends in the direction of the axis of rotation 4, such that its lateral surface extends circumferentially around the axis of rotation 4. The first bearing 27 and/or the second bearing 47 are in contact with the lateral surface of the bearing pin 12 radially to the axis of rotation 4.

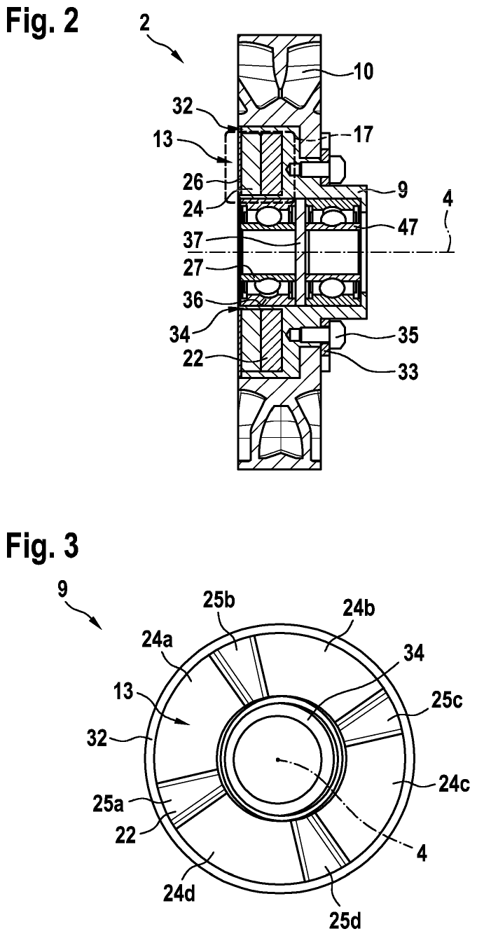

FIG. 2 shows a schematic sectional view of the magnetic rotor apparatus 2 with a compressor wheel 10, a hub 9, a locking ring 22 and at least one bearing 27, 47 is shown. The magnetic rotor apparatus 2 shown is a component of the side channel compressor 1 for the fuel cell system 31 for conveying and/or compacting a gaseous medium, in particular hydrogen. The magnetic rotor apparatus 2 can be located at least nearly entirely in the rotor space 46 and can be supported such that it can be rotated about the axis of rotation 4 and can be driven by means of the drive 6. The magnetic rotor apparatus 2 comprises the compressor wheel 10, by means of which a gas flow can be generated, in particular in the compressor space 30. Furthermore, the magnetic rotor apparatus 2 comprises the hub 9, the locking ring 22 and at least one bearing 27, 47.

Furthermore, FIG. 2 shows that the hub 9 comprises a recess 13 extending around the rotation axis 4 in an annular fashion which can be encapsulated by the rotor space 46, wherein the components of the locking ring 22 and at least two segment magnets 24, ideally four segment magnets 24, are located almost completely in the recess 13. However, in further exemplary embodiments, six segment magnets 24 or more may also be located in the recess 13. A spacer 37 may be located between the first bearing 27 and the second bearing 47 in the direction of the axis of rotation 4, wherein a distance between the bearings, in particular in the direction of the axis of rotation 4, can be adjusted by means of the spacer 37.

As shown in FIG. 2, the rotor assembly 17 is connected to a compressor wheel 10 by means of at least one spring washer 33 and at least one screw 35. The recess 13 extends orthogonally disc-shaped to the axis of rotation 4 and is limited on its side facing away from the axis of rotation 4 by the circumferential cylindrical collar 32 of the hub and on its side facing the axis of rotation 4 via a circumferential cylindrical shoulder 34 of the hub 9. The hub 9 forms the cylindrical collar 32 at its outer diameter facing away from the axis of rotation 4 and the cylindrical shoulder 34 at its inner diameter facing the axis of rotation 4. Within the inner diameter and/or cylindrical shoulder 34 is also a bearing bore 36 having a bearing seat 45.

FIG. 2 shows that the recess 13 is open on its side facing the stator 11, in particular in the direction of the axis of rotation 4. In an exemplary embodiment of the side channel compressor 1, the recess 13 is open towards the stator 11, wherein the recess 13 can be closed and/or encapsulated by means of a cover plate 26. The cover plate 26 is attached to an end face of the hub 9 facing the stator 11, wherein the cover plate 26 is non-magnetic and can be attached to the hub 9 by means of at least one laser welding process 38. The hub 9 and/or the locking ring 22 and/or the segment magnets 24 and/or the spring washer 33 and/or the screw 35 form the rotor assembly 17.

The magnetic rotor apparatus 2 shown in FIG. 2 may comprise a variety of materials. In one exemplary embodiment of the magnetic rotor apparatus 2, the hub 9 may comprise an austenitic stainless steel, in particular X2CrNiMo17-12-2 (1.4404), the locking ring 22 may comprise an unalloyed structural steel, in particular S235JR and/or St37 and/or St52, and/or a magnetic machining steel, in particular 11SMn30. For example, the segment magnets 24 may comprise NdFeB and the cover plate 26 may comprise austenitic stainless steel, in particular X2CrNiMo17-12-2 (1.4404). In addition, the compressor wheel 10, which can comprise aluminum and/or plastic and has a stepped profile, is pushed onto the hub 9 in the direction of the axis of rotation 4 before the components hub 9 and the compressor wheel 10 come into contact with the shoulders of their stepped profile and are then screwed using the at least one spring washer 33 and the at least one screw 35.

After this mounting step, the magnetic rotor apparatus 2 may be balanced in an exemplary embodiment to keep the centrifugal forces low during operation. In this case, material is taken away at defined areas of the compressor wheel 10 and/or the hub 9. Finally, after balancing, the bearings 27, 47 and spacer 37 are pressed in across the outer diameter. In an alternative embodiment, the balancing may also be carried out as a final manufacturing step.

FIG. 3 shows a top perspective view of the hub 9 according to the invention pursuant to an exemplary embodiment with the locking ring 22 having four projections 25 and four respective segment magnets 24. It is shown that the hub 9 has the shoulder 34 circumferential about the axis of rotation 4 at its inner diameter facing the axis of rotation 4 and that the hub 9 has the collar 34 circumferential about the axis of rotation 4 at its outer diameter facing away from the axis of rotation 4. The locking ring 22 is inserted into and/or pressed into the recess 13 of the hub 9, wherein the locking ring 22 is already mounted as a pre-assembled rotor assembly 17, the locking ring 22 and the segment magnets 24 are mounted in the hub 9. In one exemplary embodiment, the locking ring 22 of the magnetic rotor apparatus 2 can comprise a first protrusion 25a, second protrusion 25b, third protrusion 25c and fourth protrusion 25d, which extends particularly in the direction of the axis of rotation 4. In alternative embodiments, the locking ring 22 may comprise at least two protrusions 25 or a plurality of protrusions 25. Here, one segment magnet 24 respectively is placed in each space between two projections 25 circumferentially about the axis of rotation 4. In this exemplary embodiment of the magnetic rotor apparatus 2, it comprises a first segment magnet 24a, a second segment magnet 24b, a third segment magnet 24c and a fourth segment magnet 24d.

Two opposing segment magnets 24 are each configured as a north pole and two opposing segment magnets 24 as a south pole, so that on a circular track, one segment magnet 24 always alternates as the north pole and south pole on a circular path that extends circumferentially around the rotation axis 4. These segment magnets 24 configured as circular segments may represent an even number of segment magnets 24 that can be magnetized, which are placed on one side of the hub 9. The projections 25 are present between the circle segments 24, which can separate the segment magnets 24 from one another laterally (in the radial revolution). In the magnetic rotor apparatus 2, the segment magnets 24 must be fixed in order to transfer the torque of the drive 6 as well as an optional axial magnetic force. This function is assumed by the locking ring 22 permanently connected to the hub 9.

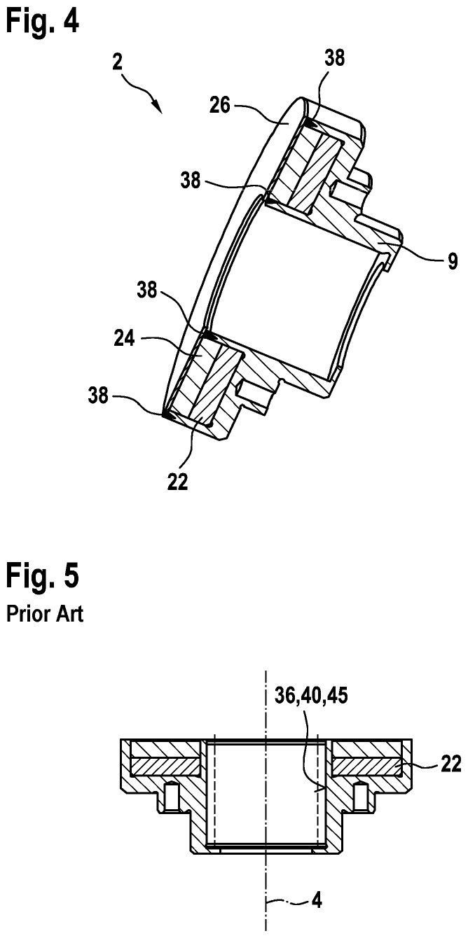

FIG. 4 shows a perspective sectional view of the rotor assembly 17 according to the invention including the cover plate 26. In this case, it is shown that the cover plate 26 in this exemplary embodiment of the magnetic rotor apparatus 2 is attached to the collar 32 and to the shoulder 34 by means of a material-locking method, in particular laser welding, in such a way that a encapsulation of the recess 13, in particular a gas-tight encapsulation takes place. Thus, the recess 13 opened towards the stator 11 is closed and/or encapsulated by means of the cover plate 26. A respective laser weld seam 38 in the collar 32 and/or in the shoulder 34 can either consist of a plurality of dotted laser welds 38 around the rotational axis 4, which extend from the cover plate 26 into the hub 9 in a pin-shaped fashion. However, it can also be a respective weld seam in the collar 32 and/or in the shoulder 34 that extends in an annular fashion around the rotation axis 4.

FIG. 5 shows a schematic cross-sectional view of the rotor assembly 17 according to the invention in accordance with the prior art. The locking ring 22 is pressed into the hub 9 in the area of the surface 40. This pressing causes the bearing bore 36 to deform. Subsequent assembly of the respective bearings 27, 47, which are in particular ball bearings 27, 47, may be very difficult to achieve due to the deformation in the area of the surface and may damage the bearings 27, 47 in advance, so that the probability of failure of the bearings 27, 47 and thus the entire side channel compressor 1 is increased.

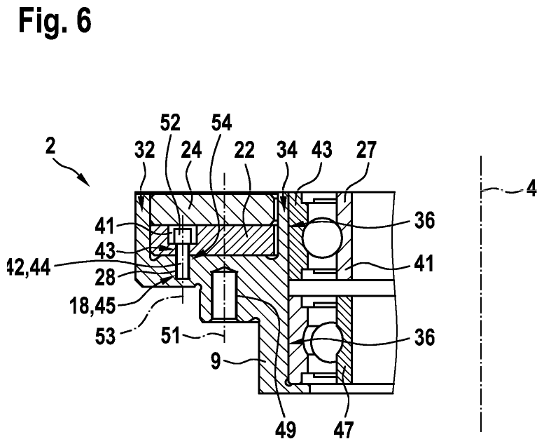

In FIG. 6, a schematic sectional view of the rotor apparatus 2 according to a first exemplary embodiment is shown. It is shown that the locking ring 22 is connected to the hub 9 by means of at least one dowel pin 42 and/or a screw element 44. The dowel pin 42 and/or the screw element 44 can be located between the outer diameter of the locking ring 22 and a first central axis 51 of a threaded bore 49 in the hub 9. Furthermore, it is shown that the hub 9 has the bearing seat 45 in the form of the bearing bore 36 at its inner diameter, wherein the first bearing 27 and/or the second bearing 47 are located in this area. The respective bearing 27, 47 comprises an outer bearing ring 43 and an inner bearing ring 41, wherein the respective bearing 27, 47 is pressed into the bearing bore 36 of the hub 9 with the outer diameter of the outer bearing ring 43.

Furthermore, FIG. 6 shows that the respective dowel pin 42 and/or the respective screw element 44 have a body 54. Optionally, the respective dowel pin 42 and/or the respective screw element 44 may have a head 52, wherein the head 52 may have a larger diameter than the body 54. Further, in particular after assembly, the respective dowel pin 42 and/or the respective screw element 44 is located with the head 52 in a first recess 41 of the locking ring 22 and with the body 54 in a second recess 43 of the locking ring 22 and a third recess 45 of the hub 9. In an exemplary embodiment of the magnetic rotor apparatus 2, the body 54 of the respective dowel pin 42 can have a larger diameter than the respective third recess 45, such that a friction-locking and/or friction-type connection, in particular a compression joint, is formed between the respective dowel pin 42 and/or the hub 9.

It is also shown in FIG. 6 that the respective dowel pin 42 and/or the respective screw element 44 are located in a non-central area of a first central axis 51 of a threaded bore 49 and the axis of rotation 4. The respective dowel pin 42 and/or the respective screw element 44 run or are positioned at least approximately parallel to the axis of rotation 4. The respective dowel pin 42 and/or the respective screw element 44 extend rotationally symmetrically around a second central axis 53. The second central axis 53 can be at least nearly parallel to the axis of rotation 4 and/or the first central axis 51. The third recess 45 in the hub 9 comprises a thread 18, in particular an internal thread 18, and the respective screw element 44 comprises a thread 28 in the area of the body 54, in particular an external thread 28, wherein the screw element 44 is screwed to the hub 9.

As shown in FIG. 6, the locking ring 22 may be attached using the respective dowel pin 42 and/or the respective screw element 44 without deforming the bearing bore 36 and/or the bearing seat 45 of the hub 9. The bearing bore 36 serves as the bearing seat 45 and therefore has very narrow tolerance requirements. The hub 9 is made of a soft, non-magnetic, weldable, austenitic stainless steel. This and the very low wall thickness in the area of the circumferential cylindrical shoulder 34 is the reason that the bearing bore 36 can deform in the prior art shown in FIG. 5 for the pressed-in locking ring 22 having a high stiffness. Thus, by means of the configuration of the magnetic rotor apparatus 2 according to the invention with the respective dowel pin 42 and/or the respective screw element 44, deformation of the bearing bore 36 and/or the bearing seat 45 is prevented, which, when the respective bearing 27, 47 is pressed in, leads to a greatly reduced bearing play, which would negatively affect the bearing life due to the temperature variations (specifically at low temperatures). The respective dowel pin 42 and/or the respective screw element 44 is as far away from the bearing seat 45 as possible, so that at least almost no deformation of the bearing size 45 can be expected from the insertion of the dowel pin 42 and/or the screw element 44. Thus, due to the design of the magnetic rotor apparatus 2 according to the invention, after the assembly of the rotor assembly 17, no extensive regrinding of the bearing bore 36 is required. The task is to design a connection that does not deform the bearing bore 36 after assembly and does not require the bearing bore 36 to be ground out later, which makes the parts less expensive. Resulting advantages are an increase in the life of the bearings 27, 47, easier and less expensive manufacturing of the magnetic rotor apparatus 2, since expensive grinding processes are omitted.

As shown in FIG. 6, a manufacturing process and/or a method for manufacturing the magnetic rotor apparatus 2 for the side channel compressor 1 and/or the fuel cell system 31 can also be used. The manufacturing process or method may be completed via the following steps to form the magnetic rotor apparatus 2:
providing a locking ring 22, wherein the locking ring 22 comprises at least two protrusions 25; a segment magnet 24 can be attached between each set of two protrusions,
installation of the locking ring 22 or insertion in the direction of the rotational axis 4 into the recess 13 of the hub 9, wherein the locking ring 22 is fixed to the hub 9 by means of at least one dowel pin 42 and/or a screw element 44, in particular in a positive-locking or friction-locking manner,
connecting the respective segment magnet 24 to the locking ring 22, in particular to an end face of the locking ring 22 and/or to the respective protrusions 25, by way of a positive-locking, material-locking, or force-locking method for forming the rotor assembly 17,

Further, in the method, the at least one dowel pin 42 with its body 54 can be pressed into the third recess 45 such that a friction-locking and/or friction-type connection forms between the respective dowel pin 42 and the hub 9. In so doing, the locking ring 22 and/or the rotor assembly 17 are fixed to the hub 9. Furthermore, a method is claimed in which the at least one screw element 44 is screwed into the third recess 45 of the hub 9 to extend the length of the screw element 44. The enlarged head 52 of the screw element 44 is in contact with an end face of the locking ring 22 in the direction of the axis of rotation, so that the locking ring 22 is fixed to the hub 9 in a friction-type and/or positive-locking manner.

1. A magnetic rotor apparatus (2) for a side channel compressor (1) for a fuel cell system (31) for conveying and/or compacting a gaseous medium, wherein the magnetic rotor apparatus (2) is rotatable about an axis of rotation (4) and/or can be driven by a drive (6), wherein the magnetic rotor apparatus (2) comprises a compressor wheel (10) configured to generate a gas flow, a hub (9), a locking ring (22) and at least one bearing (27, 47), wherein the hub (9) comprises an annular recess (13) extending around the axis of rotation (4) and encapsulating from a rotor space (46), wherein the components of the locking ring (22) and at least two segment magnets (24), are located at least almost completely in the recess (13), wherein the locking ring (22) is connected to the hub (9) by at least one dowel pin (42) and/or a screw element

2. The magnetic rotor apparatus (2) according to claim 1, wherein the respective dowel pin (42) and/or the respective screw element (44) comprises a body (54).

3. The magnetic rotor apparatus (2) according to claim 2, wherein the respective dowel pin (42) and/or the respective screw element (44) is located with a head (52) in a first recess (41) of the locking ring (22) and is located with the body (54) in a second recess (43) of the locking ring (22) and a third recess (45) of the hub (9).

4. The magnetic rotor apparatus (2) according to claim 3, wherein the body (54) of the respective dowel pin (42) has a larger diameter than the respective third recess (45), such that a friction-locking and/or friction-type connection is formed between the respective dowel pin (42) and/or the hub (9).

5. The magnetic rotor apparatus (2) according to claim 3, wherein the third recess (45) in the hub (9) comprises a thread (18) and the respective screw element (44) comprises a thread (28) in the area of the body (54), wherein the screw element (44) is screwed to the hub (9).

6. The magnetic rotor apparatus (2) according to claim 1, wherein the respective dowel pin (42) and/or the respective screw element extend or are positioned at least approximately parallel to the axis of rotation (4).

7. The magnetic rotor apparatus (2) according to claim 1, wherein the respective dowel pin (42) and/or the respective screw element is in a non-central area of a first central axis (51) of a threaded bore (49) and the rotational axis

8. A side channel compressor (1) with a stator (11) and a magnetic rotor apparatus (2) according to claim 1.

9. A fuel cell system (31) having a side channel compressor (1) according to claim 8, wherein the side channel compressor (1) is disposed in an anode circuit of the fuel cell system (31).

10. A method for manufacturing a magnetic rotor apparatus (2) for a side channel compressor (1) and/or a fuel cell system (31) according to claim 1, the method comprising:
providing a locking ring (22), wherein the locking ring (22) comprises at least two protrusions (25); a segment magnet (24) can be attached between each set of two protrusions,
installation of the locking ring 22 or insertion in a direction of the rotational axis (4) into the recess (13) of the hub (9), wherein the locking ring (22) is fixed to the hub (9) by of at least one dowel pin (42) and/or a screw element (44),
connecting the respective segment magnet (24) to the locking ring (22) by way of a positive-locking, material-locking, or force-locking method for forming the rotor assembly (17).

11. The method according to claim 10, in which the at least one dowel pin (42) with a body (54) is pressed into a third recess (45) of the hub (9) such that a friction-locking and/or friction-type connection between the respective dowel pin (42) and the hub (9) is formed and thus the locking ring (22) and/or the rotor assembly (17) is fixed to the hub (9).

12. The method according to claim 10, in which the at least one screw element (44) is screwed into a third recess (45) of the hub (9) to extend a length of the screw element (44), an enlarged head (52) of which is in contact with an end face of the locking ring (22) in a direction of the axis of rotation, so that the locking ring (22) is fixed in place on the hub (9) in a friction-locking and/or friction-type and/or positive-locking manner.

13. The magnetic rotor apparatus (2) according to claim 1, wherein the gaseous medium is hydrogen.

14. The magnetic rotor apparatus (2) according to claim 1, wherein the compressor wheel (10) generates the gas flow in a compressor space (30).

15. The magnetic rotor apparatus (2) according to claim 1, wherein four segment magnets (24) are located almost completely in the recess (13).

16. The magnetic rotor apparatus (2) according to claim 2, wherein, the respective dowel pin (42) and/or the respective screw element has a head (52), wherein the head (52) has a larger diameter than the body (54).

17. The magnetic rotor apparatus (2) according to claim 4, wherein the friction-locking and/or friction-type connection defines a compression joint formed between the respective dowel pin (42) and/or the hub (9).

18. The magnetic rotor apparatus (2) according to claim 5, wherein the thread in the third recess (45) of the hub (9) comprises an internal thread (18), and the thread (28) of the respective screw element (44) comprises an external thread (28).

19. The method according to claim 10, wherein connecting the respective segment magnet (24) to the locking ring (22) includes connecting the respective magnet (24) to an end face of the locking ring (22) and/or to the respective protrusions (25).
